(19) United States
(12) Patent Application Publication
(10) Pub. No.: US 2023/0122645 A1
(43) Pub. Date: Apr. 20, 2023

(54) AUDIO DATA PROCESSING

(71) Applicant: BEIJING BAIDU NETCOM SCIENCE TECHNOLOGY CO., LTD., Beijing (CN)

(72) Inventors: Rui Qing, Beijing (CN); Zheng Li, Beijing (CN)

(73) Assignee: BEIJING BAIDU NETCOM SCIENCE TECHNOLOGY CO., LTD., Beijing (CN)

(21) Appl. No.: 18/085,533

(22) Filed: Dec. 20, 2022

(30) Foreign Application Priority Data
Dec. 27, 2021 (CN) 202111616827.1

(51) Int. Cl. H04S 7/00

(52) U.S. Cl. CPC H04S 7/301; H04S 7/302; H04S 2420/01

(57) ABSTRACT

A method is provided that includes: obtaining initial acoustic characteristics of a spatial sound field corresponding to a venue; adjusting the initial acoustic characteristics based on at least one adjustment parameter to obtain adjusted acoustic characteristics; and applying the adjusted acoustic characteristics to audio data to obtain audio data with sound effect restored.

### CROSS-REFERENCE TO RELATED APPLICATIONS

This application claims priority to Chinese patent application No. 202111616827.1, filed on Dec. 27, 2021, the contents of which are hereby incorporated by reference in their entirety for all purposes.

### TECHNICAL FIELD

The present disclosure relates to the technical field of speech sounds, in particular to audio processing technologies, and specifically to an audio data processing method, an electronic device, and a computer-readable storage medium.

### BACKGROUND

With the progress and development of society and technology, online speeches, shows or performances, launches, and other events become increasingly frequent with the help of Internet media, and the demand and requirements for this also become increasingly high. Especially for such large-scale online events with an audience of a large number of online participants, the sound effects that the audience can experience during this period are critical.

The methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

According to an aspect of the present disclosure, a method is provided. The method includes: obtaining initial acoustic characteristics of a spatial sound field corresponding to a venue; adjusting the initial acoustic characteristics based on at least one adjustment parameter to obtain adjusted acoustic characteristics; and applying the adjusted acoustic characteristics to audio data to obtain audio data with sound effect restored.

According to an aspect of the present disclosure, an electronic device is provided. The electronic device includes: a processor; and a memory communicatively connected to the processor, wherein the memory stores instructions executable by the processor, wherein the instructions, when executed by the processor, are configured to cause the processor to perform operations including: obtaining initial acoustic characteristics of a spatial sound field corresponding to a venue; adjusting the initial acoustic characteristics based on at least one adjustment parameter to obtain adjusted acoustic characteristics; and applying the adjusted acoustic characteristics to audio data to obtain audio data with sound effect restored.

According to an aspect of the present disclosure, a non-transitory computer-readable storage medium is provided. The non-transitory computer-readable storage medium stores computer instructions, wherein the computer instructions are configured to enable a computer to perform operations including: obtaining initial acoustic characteristics of a spatial sound field corresponding to a venue; adjusting the initial acoustic characteristics based on at least one adjustment parameter to obtain adjusted acoustic characteristics; and applying the adjusted acoustic characteristics to audio data to obtain audio data with sound effect restored.

### BRIEF DESCRIPTION OF THE DRAWINGS

The accompanying drawings show embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of an audio data processing method according to an embodiment of the present disclosure;

FIG. 3 is a schematic diagram of obtaining sound reception data about a venue according to an embodiment of the present disclosure;

FIG. 4 is a structural block diagram of an audio data processing apparatus according to an embodiment of the present disclosure;

FIG. 5 is a structural block diagram of an audio data processing apparatus according to another embodiment of the present disclosure; and

FIG. 6 is a structural block diagram of an example electronic device that can be used to implement an embodiment of the present disclosure.

### DETAILED DESCRIPTION OF EMBODIMENTS

Embodiments of the present disclosure are described below with reference to the accompanying drawings, where various details of the embodiments of the present disclosure are included for a better understanding, and should be considered as merely example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from the other. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

In the related art, sound effects available for large-scale online speeches, shows or performances, launches, etc. (for example, with an audience of tens of thousands of online participants) usually cannot match those of real large venues (e.g., stadiums, indoor halls, or outdoor open-air stages). This is because an audio stream generated online generally can only be received by a microphone arranged at a close distance, imposing certain limitations on the provision of the sound effects. As a result, even if the audience participates in such large-scale events online, they cannot feel the same spatial sound effects as they can experience in the real large venues.

In addition, with the development of virtual reality (VR) technology, it has been possible to create a virtual space populated by tens of thousands of people that simulates the real world. However, there are still gaps in technology as to whether users can experience the same as in the real world when entering such a virtual space populated by tens of thousands of people.

In view of at least the above problems, according to an aspect of the present disclosure, there is provided an audio data processing method for restoring a venue sound effect. The embodiments of the present disclosure will be described below in detail with reference to the accompanying drawings.

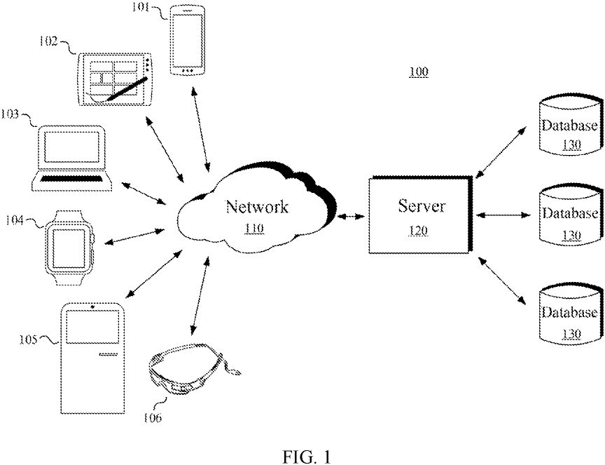

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more application programs.

In an embodiment of the present disclosure, the server 120 can run one or more services or software applications that enable an audio data processing method for restoring a venue sound effect to be performed.

In some embodiments, the server 120 may further provide other services or software applications that may include a non-virtual environment and a virtual environment. In some embodiments, these services may be provided as web-based services or cloud services, for example, provided to a user of the client device 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client device 101, 102, 103, 104, 105, and/or 106 may sequentially use one or more client application programs to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

A user may use the client device 101, 102, 103, 104, 105, and/or 106 to log in to, access, or join in online events such as speeches, shows or performances, or launches. The client device may provide an interface that enables the user of the client device to interact with the client device. The client device may also output information to the user via the interface. Although FIG. 1 depicts only six types of client devices, those skilled in the art will understand that any number of client devices are possible in the present disclosure.

The client device 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software application programs and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various application programs, such as various Internet-related application programs, communication application programs (e.g., email application programs), and short message service (SMS) application programs, and can use various communication protocols.

The network 110 may be any type of network well known to those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above-mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may include one or more application programs to analyze and merge data feeds and/or event updates received from users of the client device 101, 102, 103, 104, 105, and/or 106. The server 120 may further include one or more application programs to display the data feeds and/or real-time events via one or more display devices of the client device 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as an audio file and a video file. The databases 130 may reside in various locations. For example, a database used by the server 120 may be locally in the server 120, or may be remote from the server 120 and may communicate with the server 120 via a network-based or dedicated connection. The databases 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application program to store application program data. The database used by the application program may be of different types, for example, may be a key-value repository, an object repository, or a regular repository backed by a file system.

The system 100 of FIG. 1 may be configured and operated in various manners, such that the various methods and apparatuses described according to the present disclosure can be applied.

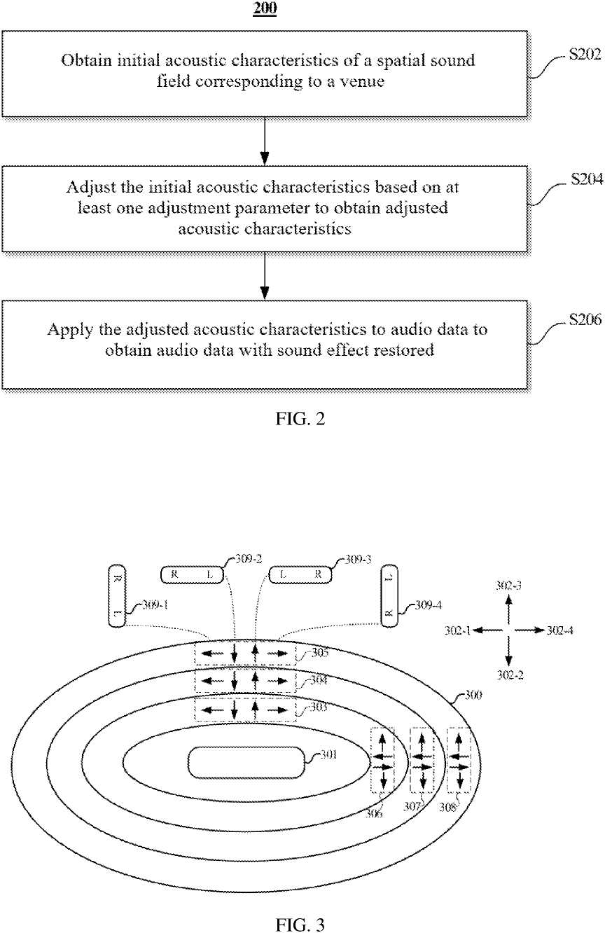

FIG. 2 is a flowchart of an audio data processing method 200 for restoring a venue sound effect according to an embodiment of the present disclosure. As shown in FIG. 2, the method 200 may include the following steps:

Step S202: obtaining initial acoustic characteristics of a spatial sound field corresponding to a venue;

Step S204: adjusting the initial acoustic characteristics based on at least one adjustment parameter to obtain adjusted acoustic characteristics; and

Step S206: applying the adjusted acoustic characteristics to audio data to obtain audio data with sound effect restored.

According to the audio data processing method of the present disclosure, acoustic characteristics of a real venue may be obtained and adjusted, so as to simulate spatial sound effects of the real venue for online events such as speeches, shows or performances, or launches. In this way, an audience participating online can experience the same spatial sound effects as they can experience in the real venue.

The steps of the audio data processing method according to the present disclosure will be described in detail below.

It should be noted that the term “venue” referred to in the present disclosure may be a space, a place, or a building such as a stadium, an indoor hall, an outdoor open-air stage, etc. for holding various public events or assemblies, which may be on a large or super-large scale, for example, can accommodate 10,000 or 100,000 people (such as the National Stadium “Bird’s Nest”), and may have an open or closed structure. Since there are various forms of venues in practical applications, the use of the term “venue” is intended to explain and convey the inventive concept of the present disclosure. The present disclosure does not impose unnecessary limitations on the type, structure, or scale of the venue.

In the technical solutions of the present disclosure, collection, storage, use, processing, transmission, provision, disclosure, etc. of user personal information involved all comply with related laws and regulations and are not against the public order and good morals.

In step S202, the initial acoustic characteristics of the spatial sound field corresponding to the venue may include an overall frequency response of a complete set of speaker equipment arranged in the venue, a room impulse response (RIR) of the super-large venue, a spatial direction feature, etc. Generally, the complete set of speaker equipment arranged in the venue is often designed to match the current venue, and accordingly the initial acoustic characteristics include acoustic characteristics associated with such speaker equipment.

The acoustic characteristics of the spatial sound field corresponding to the venue can reflect various attributes of the spatial sound field. The acoustic characteristics may be obtained based on raw stereo data acquired from the venue, and thus may be referred to as the initial acoustic characteristics herein. The initial acoustic characteristics may correspond to initial filter coefficients for restoring a sound effect of the venue. As will be further described below in conjunction with steps S204 and S206, the initial acoustic characteristics, i.e., the initial filter coefficients are subjected to parameter adjustments in different dimensions, to finally obtain filter coefficients that can be used to restore the sound effect of the venue.

According to some embodiments, step S202 of obtaining initial acoustic characteristics of a spatial sound field corresponding to a venue may include: obtaining sound reception data about the venue, where the sound reception data is obtained by recording played audio at a preset position in the venue; and obtaining the initial acoustic characteristics of the spatial sound field based on the played audio and the sound reception data.

In the manner described above, the acoustic characteristics of the corresponding spatial sound field can be flexibly obtained based on the venue of interest for sound effect restoration, and further data sources (the played audio and the corresponding sound reception data) that are easily acquired or obtained can be used to obtain the acoustic characteristics of the spatial sound field.

In practical applications, sound reception data can be used mutually for venues of similar sizes (for example, 100,000 people and 80,000 people). This means that if sound reception data for a venue of 100,000 people cannot be obtained, sound reception data available for another venue of a similar size can be used instead.

Generally, for the purpose of better obtaining the acoustic characteristics of the sound field, the audio played during the recording of the sound reception data in the venue may be preset. For example, the played audio may cover various sound frequency bands that are desired or of interest, such as human voice, white noise, and swept frequency signals. Therefore, the sound reception data obtained by recording may also include the corresponding sound frequency bands.

Herein, to obtain the acoustic characteristics of the sound field, the audio played during the recording of the sound reception data in the venue may be considered as source data, and the sound reception data may be considered as result data, where the result data can reflect a result after the source data goes through the venue. Therefore, such a process of going through the venue can be derived based on the source data and the result data, that is, the acoustic characteristics of the spatial sound field corresponding to the venue are obtained.

According to some embodiments, the obtaining the initial acoustic characteristics of the spatial sound field may include: performing correlation modeling on the played audio and the sound reception data to extract the initial acoustic characteristics through a deconvolution operation.

In the manner described above, the acoustic characteristics of the sound field can be derived by using a correlation between the data sources (the played audio and the corresponding sound reception data) that are easily acquired or obtained.

The correlation modeling may include obtaining a correlation function between the played audio and the sound reception data. The initial acoustic characteristics extracted through the deconvolution operation may correspond to the initial filter coefficients for restoring the sound effect of the venue as described above. Considering that the deconvolution operation is a method known in the art, its details are not elaborated herein so as not to obscure the gist of the present disclosure.

According to some embodiments, the sound reception data may meet at least one of the following conditions: being associated with at least one spatial direction in the venue, or being associated with a distance from the center of the venue.

In the manner described above, the sound reception data can cover attributes in the spatial direction and distance, such that the acoustic characteristics of the sound field obtained therefrom can be closer to the case of the real venue.

Herein, characteristics of the sound reception data in the spatial direction and distance are described in detail with reference to FIG. 3. FIG. 3 is a schematic diagram of obtaining sound reception data about a venue according to an embodiment of the present disclosure.

FIG. 3 shows a venue 300 in a top view, and for ease of description, the venue 300 is shown as a stadium. However, as described above, the present disclosure does not impose unnecessary limitations on the type, structure, or scale of the venue.

The venue 300 may have a center 301. The center 301 is shown in FIG. 3 as a football field, at the center of the stadium, which is surrounded by running tracks shown as ringshaped. In addition, the venue 300 may further have four spatial directions 302-1 to 302-4, the orientations of which are shown by arrows on the right in FIG. 3.

As described above, the sound reception data may be obtained by recording the played audio at the preset position in the venue. Specifically, FIG. 3 schematically shows recording points 303 to 308 as preset positions, where distances of the recording points 303 to 305 and of the recording points 306 to 308 from the center 301 increase sequentially. Additionally, at each of the recording points 303 to 308, the audio may be recorded in the four spatial directions 302-1 to 302-4. The four spatial directions 302-1 to 302-4 are shown with different arrow orientations at each recording point.

Therefore, the recording points are arranged in association with at least one spatial direction in the venue, and in association with a distance from the center of the venue, such that the recorded sound reception data also meets at least one of the following conditions: being associated with at least one spatial direction in the venue, or being associated with a distance from the center of the venue.

Those skilled in the art can understand that FIG. 3 is only an example illustration of the recording points, and the present disclosure is not intended to impose unnecessary limitations thereon. In practical applications, a trade-off between efficiency and effect often needs to be considered during the selection of the recording points. For example, considering the cost of data acquisition, FIG. 3 shows a case in which the recording points 303 to 305 are in the upper part of the figure and the recording points 306 to 308 are in the right part of the figure. However, if possible, more recording points may be further arranged to be located between the recording points 303 to 305 and the recording points 306 to 308, thereby making it easy to obtain more accurate acoustic characteristics of the spatial sound field.

According to some embodiments, the sound reception data may be obtained by recording the played audio through a simulation of human ears picking up a sound.

Still referring to FIG. 3, various orientations 309-1 to 309-4 of artificial ear recording devices placed at the recording points 303 to 308 are shown. Herein, the artificial ear recording device can simulate the head and ear structure of a real person in appearance. The corresponding recording devices are placed in the ears (e.g., inside the pinnae), that is, one left and one right (as shown by the signs “L” and “R” in FIG. 3), so as to simulate an effect of the real human ears picking up a sound, such as the sense of direction. It can be understood that for each of the recording points 303 to 308 shown in FIG. 3, four artificial ear recording devices may be used in one recording and respectively oriented in the four directions; or one artificial ear recording device may be used for four recordings and oriented in a different direction during each of the recordings.

It should be noted that the simulation of the head and ear structure of the real person in this embodiment is not specific to a particular user, and cannot reflect personal information of the particular user.

In the manner described above, the sound reception data can truly simulate the effect of the human ears picking up a sound, such that the acoustic characteristics of the sound field obtained therefrom can be closer to the case of the audience in the real venue.

Referring back to FIG. 2, in step S204, as described above, the initial acoustic characteristics may correspond to the initial filter coefficients for restoring the sound effect of the venue, and the adjusted acoustic characteristics obtained by adjusting the initial acoustic characteristics based on the at least one adjustment parameter may correspond to the filter coefficients that can be finally used to reproduce the sound effect of the venue. In this way, the use of the obtained filter coefficients enables the online audience to experience the same spatial sound effects as they can experience in the real venue.

According to some embodiments, the at least one adjustment parameter may include at least one of the following: a reverberation time, an echo volume, an equalization degree, or a propagation decay.

In the manner described above, filter coefficients for sound effect restoration can be designed as required according to different sound effect restoration requirements.

The reverberation time may be a reverberation time T60, which reflects a time it takes for sound energy to decay by 60 dB. How long echoes last can be controlled by controlling the reverberation time, thereby allowing for optimization of echo effects at different positions in the venue.

The echo volume, also referred to as an echo component, can be controlled by means of an echo volume decay curve. Controlling the echo volume can prevent the human voice from being affected by relatively loud echoes. For example, when a speaker’s voice is relatively low or sharp, their voice may be easily drowned by echoes. In this case, the echo volume may be optimized to avoid the echo effect.

The equalization degree may be used for a sound quality adjustment. More uniform sound quality can be obtained by controlling the equalization degree.

The propagation decay may relate to an adjustment to the sense of distance, that is, increasing or decreasing the decay depending on the distance. The sense of distance more suitable for listening can be obtained by controlling the propagation decay.

The above four adjustment parameters may be selected according to actual needs. Correspondingly, different combinations of the above four adjustment parameters may correspond to different filter coefficients, thereby forming a set of optimized filter banks.

In step S206, applying the adjusted acoustic characteristics to the audio data means processing the audio data based on the adjusted acoustic characteristics.

According to some embodiments, the adjusted acoustic characteristics may include at least one filter coefficient, and the applying the adjusted acoustic characteristics to audio data to obtain audio data with sound effect restored may include: selecting one or more filter coefficients from the at least one filter coefficient based on human voice characteristics in the audio data, to obtain the audio data with sound effect restored through a convolution operation.

In the manner described above, suitable filter coefficients for restoring the sound effect of the venue can be selected based on characteristics of a speaker’s voice in an event such as an online speech, thereby further improving the sound effect experienced by the audience.

For example, in the above case where the speaker’s voice is relatively low or sharp and therefore is easily drowned by echoes, an adjusted filter parameter of the echo volume may be used for restoration of the sound effect of the venue.

In addition, it is noted that considering that the convolution operation is a method known in the art, its details are not elaborated herein so as not to obscure the gist of the present disclosure.

As described above, according to the audio data processing method of the present disclosure, acoustic characteristics of a real venue may be obtained and adjusted, so as to simulate spatial sound effects of the real venue for online events such as speeches, shows or performances, or launches. In this way, an audience participating online can experience the same spatial sound effects as they can experience in the real venue.

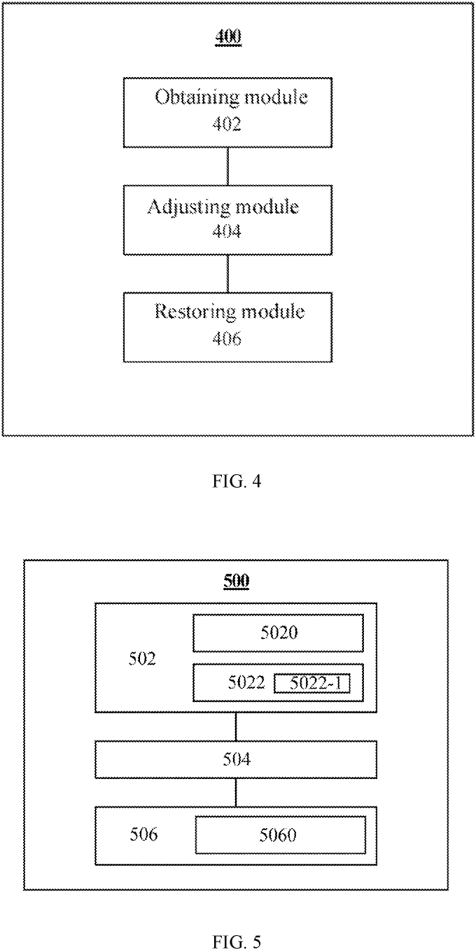

According to another aspect of the present disclosure, an audio data processing apparatus for restoring a venue sound effect is further provided. FIG. 4 is a block diagram of an audio data processing apparatus 400 according to an embodiment of the present disclosure.

As shown in FIG. 4, the apparatus 400 may include: an obtaining module 402 configured to obtain initial acoustic characteristics of a spatial sound field corresponding to a venue; an adjusting module 404 configured to adjust the initial acoustic characteristics based on at least one adjustment parameter to obtain adjusted acoustic characteristics; and a restoring module 406 configured to apply the adjusted acoustic characteristics to audio data to obtain audio data with sound effect restored.

The operations performed by the above modules 402 to 406 may correspond to steps S202 to S206 described with reference to FIG. 2, and therefore the details of each aspect thereof are not repeated.

FIG. 5 is a block diagram of an audio data processing apparatus 500 according to another embodiment of the present disclosure. Modules 502 to 506 shown in FIG. 5 may correspond to the modules 402 to 406 shown in FIG. 4, respectively. In addition, the modules 502 and 506 may also include further sub-function modules, which are described in detail below.

According to some embodiments, the obtaining module 502 may include: a first operating module 5020 configured to obtain sound reception data about the venue, where the sound reception data is obtained by recording played audio at a preset position in the venue; and a second operating module 5022 configured to obtain the initial acoustic characteristics of the spatial sound field based on the played audio and the sound reception data.

According to some embodiments, the second operating module 5022 may include: an extracting module 5022-1 configured to perform correlation modeling on the played audio and the sound reception data to extract the initial acoustic characteristics through a deconvolution operation.

According to some embodiments, the sound reception data may meet at least one of the following conditions: being associated with at least one spatial direction in the venue, or being associated with a distance from the center of the venue.

According to some embodiments, the sound reception data may be obtained by recording the played audio through a simulation of human ears picking up a sound.

According to some embodiments, the at least one adjustment parameter may include at least one of the following: a reverberation time, an echo volume, an equalization degree, or a propagation decay.

According to some embodiments, the adjusted acoustic characteristics may include at least one filter coefficient, and the restoring module 506 may include: a third operating module 5060 configured to select one or more filter coefficients from the at least one filter coefficient based on human voice characteristics in the audio data, to obtain the audio data with sound effect restored through a convolution operation.

According to another aspect of the present disclosure, an electronic device is further provided, which includes: at least one processor; and a memory communicatively connected to the at least one processor, where the memory stores instructions executable by the at least one processor, where the instructions, when executed by the at least one processor, are configured to cause the at least one processor to implement the method according to the present disclosure.

According to another aspect of the present disclosure, a non-transitory computer-readable storage medium storing computer instructions is further provided, where the computer instructions are configured to enable a computer to implement the method according to the present disclosure.

According to another aspect of the present disclosure, a computer program product is further provided, which includes a computer program, where the computer program, when executed by a processor, implements the method according to the present disclosure.

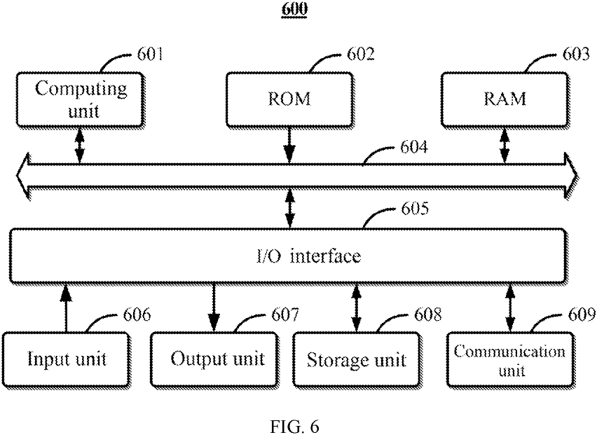

Referring to FIG. 6, a structural block diagram of an electronic device 600 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 6, the electronic device 600 includes a computing unit 601, which may perform various appropriate actions and processing according to a computer program stored in a read-only memory (ROM) 602 or a computer program loaded from a storage unit 608 to a random access memory (RAM) 603. The RAM 603 may further store various programs and data required for the operation of the electronic device 600. The computing unit 601, the ROM 602, and the RAM 603 are connected to each other through a bus 604. An input/output (I/O) interface 605 is also connected to the bus 604.

A plurality of components in the electronic device 600 are connected to the I/O interface 605, including: an input unit 606, an output unit 607, the storage unit 608, and a communication unit 609. The input unit 606 may be any type of device capable of entering information to the electronic device 600. The input unit 606 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 607 may be any type of device capable of presenting information, and may include, but is not limited to, a display, a speaker, a video/audio output terminal, a vibrator, and/or a printer. The storage unit 608 may include, but is not limited to, a magnetic disk and an optical disc. The communication unit 609 allows the electronic device 600 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, an 802.11 device, a Wi-Fi device, a WiMAX device, a cellular communication device, and/or the like.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 601 performs the various methods and processing described above, for example, the audio data processing method 200. For example, in some embodiments, the audio data processing method may be implemented as a computer software program, which is tangibly contained in a machine-readable medium, such as the storage unit 608. In some embodiments, a part or all of the computer program may be loaded and/or installed onto the electronic device 600 via the ROM 602 and/or the communication unit 609. When the computer program is loaded onto the RAM 603 and executed by the computing unit 601, one or more steps of the audio data processing method described above can be performed. Alternatively, in other embodiments, the computing unit 601 may be configured, by any other suitable means (for example, by means of firmware), to perform the audio data processing method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

In the technical solutions of the present disclosure, collection, storage, use, processing, transmission, provision, disclosure, etc. of user personal information involved all comply with related laws and regulations and are not against the public order and good morals.

Although the embodiments or examples of the present disclosure have been described with reference to the accompanying drawings, it should be appreciated that the method, system, and device described above are merely example embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method, comprising:
obtaining initial acoustic characteristics of a spatial sound field corresponding to a venue;
adjusting the initial acoustic characteristics based on at least one adjustment parameter to obtain adjusted acoustic characteristics; and
applying the adjusted acoustic characteristics to audio data to obtain audio data with sound effect restored.

2. The method according to claim 1, wherein the obtaining the initial acoustic characteristics of the spatial sound field corresponding to the venue comprises:
obtaining sound reception data about the venue, wherein the sound reception data is obtained by recording a played audio at a preset position in the venue; and
obtaining the initial acoustic characteristics of the spatial sound field based on the played audio and the sound reception data.

3. The method according to claim 2, wherein the obtaining the initial acoustic characteristics of the spatial sound field comprises:
performing correlation modeling on the played audio and the sound reception data to extract the initial acoustic characteristics through a deconvolution operation.

4. The method according to claim 2, wherein the sound reception data meets at least one of the following conditions: being associated with at least one spatial direction in the venue, or being associated with a distance from a center of the venue.

5. The method according to claim 2, wherein the sound reception data is obtained by recording the played audio through a simulation of human ears picking up a sound.

6. The method according to claim 1, wherein the at least one adjustment parameter comprises at least one of the following: a reverberation time, an echo volume, an equalization degree, or a propagation decay.

7. The method according to claim 1, wherein the adjusted acoustic characteristics comprise at least one filter coefficient, and wherein the applying the adjusted acoustic characteristics to the audio data to obtain the audio data with sound effect restored comprises:
selecting one or more filter coefficients from the at least one filter coefficient based on human voice characteristics in the audio data, to obtain the audio data with sound effect restored through a convolution operation.

8. An electronic device, comprising:
a processor; and
a memory communicatively connected to the processor, wherein
the memory stores instructions executable by the processor, wherein the instructions, when executed by the processor, are configured to cause the processor to perform operations comprising:
obtaining initial acoustic characteristics of a spatial sound field corresponding to a venue;
adjusting the initial acoustic characteristics based on at least one adjustment parameter to obtain adjusted acoustic characteristics; and
applying the adjusted acoustic characteristics to audio data to obtain audio data with sound effect restored.

9. The electronic device according to claim 8, wherein the obtaining the initial acoustic characteristics of the spatial sound field corresponding to the venue comprises:
obtaining sound reception data about the venue, wherein the sound reception data is obtained by recording a played audio at a preset position in the venue; and
obtaining the initial acoustic characteristics of the spatial sound field based on the played audio and the sound reception data.

10. The electronic device according to claim 9, wherein the obtaining the initial acoustic characteristics of the spatial sound field comprises:
performing correlation modeling on the played audio and the sound reception data to extract the initial acoustic characteristics through a deconvolution operation.

11. The electronic device according to claim 9, wherein the sound reception data meets at least one of the following conditions: being associated with at least one spatial direction in the venue, or being associated with a distance from a center of the venue.

12. The electronic device according to claim 9, wherein the sound reception data is obtained by recording the played audio through a simulation of human ears picking up a sound.

13. The electronic device according to claim 8, wherein the at least one adjustment parameter comprises at least one of the following: a reverberation time, an echo volume, an equalization degree, or a propagation decay.

14. The electronic device according to claim 8, wherein the adjusted acoustic characteristics comprise at least one filter coefficient, and wherein the applying the adjusted acoustic characteristics to the audio data to obtain the audio data with sound effect restored comprises:
selecting one or more filter coefficients from the at least one filter coefficient based on human voice characteristics in the audio data, to obtain the audio data with sound effect restored through a convolution operation.

15. A non-transitory computer-readable storage medium storing computer instructions, wherein the computer instructions are configured to enable a computer to perform operations comprising:
obtaining initial acoustic characteristics of a spatial sound field corresponding to a venue;
adjusting the initial acoustic characteristics based on at least one adjustment parameter to obtain adjusted acoustic characteristics; and
applying the adjusted acoustic characteristics to audio data to obtain audio data with sound effect restored.

16. The non-transitory computer-readable storage medium according to claim 15, wherein the obtaining the initial acoustic characteristics of the spatial sound field corresponding to the venue comprises:
obtaining sound reception data about the venue, wherein the sound reception data is obtained by recording a played audio at a preset position in the venue; and
obtaining the initial acoustic characteristics of the spatial sound field based on the played audio and the sound reception data.

17. The non-transitory computer-readable storage medium according to claim 16, wherein the obtaining the initial acoustic characteristics of the spatial sound field comprises:
performing correlation modeling on the played audio and the sound reception data to extract the initial acoustic characteristics through a deconvolution operation.

18. The non-transitory computer-readable storage medium according to claim 16, wherein the sound reception data meets at least one of the following conditions: being associated with at least one spatial direction in the venue, or being associated with a distance from a center of the venue.

19. The non-transitory computer-readable storage medium according to claim 16, wherein the sound reception data is obtained by recording the played audio through a simulation of human ears picking up a sound.

20. The non-transitory computer-readable storage medium according to claim 15, wherein the at least one adjustment parameter comprises at least one of the following: a reverberation time, an echo volume, an equalization degree, or a propagation decay.
